(19) United States
(12) Patent Application Publication
(10) Pub. No.: US 2023/0023207 A1
(43) Pub. Date: Jan. 26, 2023

(54) CRANKTRAIN PHASE ADJUSTER FOR VARIABLE COMPRESSION RATIO

(71) Applicant: Schaeffler Technologies AG & Co .KG, Herzogenaurach (DE)

(72) Inventors: Nicholas Hrusch, Wooster, OH (US); Jonathan Jameson, Dalton, OH (US); Todd Sturgin, Wooster, OH (US)

(73) Assignee: Schaeffler Technologies AG & Co .KG, Herzogenaurach (DE)

(21) Appl. No.: 17/869,185

(22) Filed: Jul. 20, 2022

Related U.S. Application Data
(60) Provisional application No. 63/224,376, filed on Jul. 21, 2021.

(51) Int. Cl. F02B 75/04

(52) U.S. Cl. CPC F02B 75/047

(57) ABSTRACT

A phase adjuster is disclosed herein that has improvements for a number of features thereby improving the functionality of the phase adjuster and/or simplifying the manufacturing or assembly process for the phase adjuster. The phase adjuster includes an input gear and an input shaft connected to the input gear such that the input shaft is rotationally connected to the input gear and configured to be axially displaced. A piston plate is integrally formed with the input shaft. An output gear hub is operatively connected to the input shaft via the piston plate, and an output gear ring is connected to the output gear hub.

### INCORPORATION BY REFERENCE

This application claims priority to U.S. Provisional Application No. 63/224,376, which was filed on Jul. 21, 2021, and is incorporated herein by reference in its entirety.

### FIELD OF INVENTION

This disclosure is generally related to a cranktrain phase adjuster that can vary a compression ratio of an internal combustion (IC) engine.

### BACKGROUND

An IC engine with variable compression ratio (VCR) can achieve greater efficiency and improved fuel consumption than an engine with a fixed compression ratio. A low-cost and packaging-friendly phase adjuster assembly is required for a cranktrain to implement VCR in an IC engine.

VCR systems are well known, but there is a greater need for VCR systems that include manufacturing efficiencies and components that are more easily assembled.

### SUMMARY

A phase adjuster is disclosed herein that has improvements for a number of features thereby improving the functionality of the phase adjuster and/or simplifying the manufacturing or assembly process for the phase adjuster. The phase adjuster includes an input gear and an input shaft connected to the input gear such that the input shaft is rotationally connected to the input gear and configured to be axially displaced. A piston plate is integrally formed with the input shaft. An output gear hub is operatively connected to the input shaft via the piston plate, and an output gear ring is connected to the output gear hub.

The output gear hub can be formed via stamping. A support plate can also be arranged radially around at least a portion of the input shaft. The support plate can be connected to the output gear hub via at least one extruded rivet formed on the output gear hub. A plurality of extruded rivets can be formed on the output gear hub.

A seal plate and an oil control assembly can be configured to selectively provide pressure to a predetermined chamber, such as an advance or retard chamber, which can be defined on either axial side of the seal plate.

A spring assembly or spring set can be configured to engage the seal plate, and the spring assembly can include at least one first spring and at least one second spring. A spring retainer plate can include at least one inner retainer on a radially inner edge thereof that is configured to support an end of the at least one second spring, and at least one outer retainer on a radially outer edge thereof that is configured to support an end of the at least one first spring. The spring retainer plate can be formed via stamping. The at least one first spring and the at least one second spring can each be formed as wire springs with an ovate profile.

A hydraulic housing can be configured to support a locking pin that selectively engages the seal plate, and the hydraulic housing can include an integrally formed collar for supporting the locking pin.

A seal retainer plate can be provided that is configured to engage at least a portion of the seal plate. An o-ring can be configured to provide a seal interface between an outer surface of the seal plate and an inner surface of the hydraulic housing. The seal retainer plate can be configured to be press fit onto the seal plate, and the seal retainer plate can include a plurality of fingers configured to engage the seal plate to retain the seal retainer plate on the seal plate.

An input housing can be configured to house the input gear and at least a portion of the input shaft. At least one tapered roller bearing can support at least a portion of the input gear. An input cover can be configured to engage directly against the at least one tapered roller bearing. The input cover can be configured to be axially retained via a staking feature formed on the input housing.

While multiple bearings can be integrated with the phase adjuster disclosed herein, one specific bearing can be arranged on a radially outer surface of the output gear hub. The output gear hub can include a staking feature for axially retaining the bearing. An input seal plate can be configured to be press fit onto an interior surface of the input gear.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is cross-sectional view an example embodiment of a phase adjuster.

FIGS. 2A and 2B are perspective views of an example embodiment of a phase adjuster.

FIG. 3 is an exploded perspective view of the phase adjuster of FIGS. 1-2B.

FIG. 4 is a cross-sectional view illustrating a torque path that occurs within the phase adjuster of FIGS. 1-3.

FIG. 5 is a cross-sectional view of the phase adjuster of FIGS. 1-4 that illustrates relative movement of specific components.

FIGS. 6A and 6B are perspective views of an output gear ring and output gear hub.

FIG. 6C is a cross-sectional view of the output gear ring and the output gear hub.

FIG. 7 is a perspective view of a spring set.

FIG. 8 is a perspective view of an input cover that is staked to an input housing.

FIG. 9A is a perspective view of a seal retainer plate and its installation on a seal plate.

FIG. 9B is a cross-sectional view of the seal retainer plate and the seal plate in an assembled state.

### DETAILED DESCRIPTION

Certain terminology is used in the following description for convenience only and is not limiting. “Axially” refers to a direction along an axis (X) of an assembly. “Radially” refers to a direction inward and outward from the axis (X) of the assembly.

A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

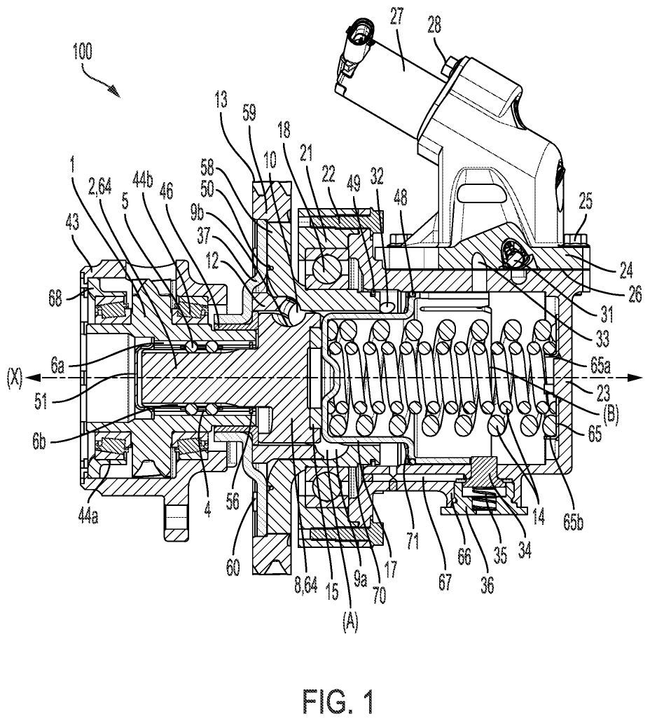

FIG. 1 illustrates a phase adjuster 100 that can be utilized within a cranktrain. For example, the cranktrain can include a crankshaft, an eccentric shaft, a connecting plate, a first connecting rod, a second connecting rod, a piston, and the phase adjuster 100. The first connecting rod can connect the eccentric shaft to the crankshaft and the second connecting rod connects the piston to the connecting plate. The connecting plate can be non-rotatably connected to the crankshaft and can rotate about a rotational axis of the crankshaft. The phase adjuster 100 can be configured to change a phase of the eccentric shaft relative to the crankshaft. In one configuration, the phase adjuster 100 can be configured to adjust a phase angle of an eccentric shaft in order to facilitate VCR. In this configuration the eccentric shaft is driven by an electric motor and is not connected via gears to the crankshaft.

The phase adjuster 100 disclosed herein shares common features with the phase adjuster disclosed in U.S. patent application Ser. No. 17/666,825, filed on Feb. 8, 2022, which is commonly owned by Schaeffler Technologies AG & CO. KG, and the entire contents of U.S. patent application Ser. No. 17/666,825 are incorporated by reference as if fully set forth herein.

Referring to FIG. 1 of the present disclosure, power (i.e. torque) enters the phase adjuster 100 through an input gear 1 from a prime mover, which can be the engine eccentric shaft or electric motor. One of ordinary skill in the art would understand that the present phase adjuster 100 can be modified to be adaptable with various types of power input and output systems and drives. The phase adjuster 100 can generally include an input assembly that is configured to be driven by one element, and an output assembly that is configured to drive another element. Each of the input and output assemblies generally include a gear or other torque transmitting element. The terms input and output assemblies can be used herein to refer to collections of components that are either associated with transmitting an input torque or receiving an output torque. The terms are also used herein to refer to additional components that are configured to support or house any of these components.

The input gear 1 can be configured to transmit torque to an input shaft 2 through a ball spline 3 interface. The ball spline can be composed of a cage 4 and a plurality of balls 5 which run on axially extending circular raceways 6a (formed on the input gear 1) and 6b (formed on the input shaft 2), which allows the connection to transmit torque while also translating axially with reduced friction. The input shaft 2 can be rotationally fixed or connected to the input gear 1 and can be configured to be axially displaced.

The input shaft 2 can be integrated with a piston plate 8 such that the input shaft 2 and the piston plate 8 are integrally formed as a single component and a unitary body 64. In one aspect, the unitary body 64 can be forged and machined. As shown in FIG. 1, the piston plate 8 can be formed as an enlarged portion of the body 64 while the input shaft 2 can be formed as a narrower portion of the body 64.

The piston plate 8 can include a plurality of spiral, bi-directional circular raceways 9b upon which balls 10 are in contact at two points (i.e. one for each side of the raceway). A similar bi-directional outer raceway 9a can be formed by a ramp ring 12 and an output gear 13, which also contacts the balls 10 in two points on its circular spiral surfaces. Further details regarding the function of this interface are provided in U.S. patent application Ser. No. 17/666,825.

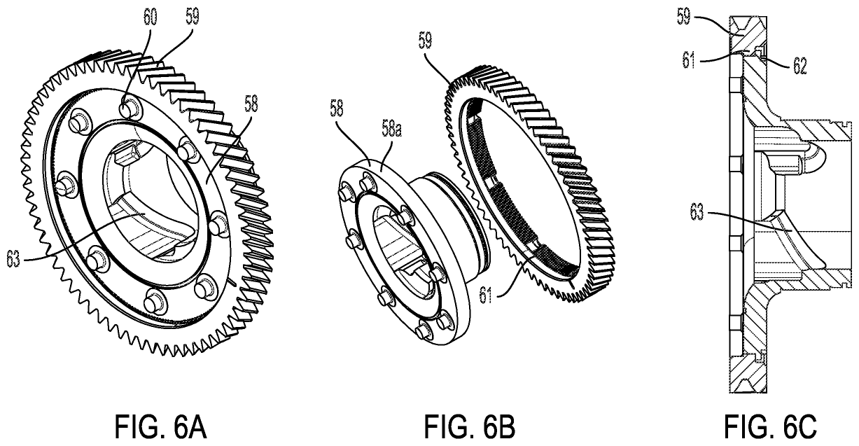

As shown in FIGS. 6A-6C, the output gear 13 can be comprised of two distinct and separately formed components, i.e. an output gear hub 58 and an output gear ring 59. In one example, the output gear hub 58 is formed as a stamped component. The output gear hub 58 can be configured to be operatively connected to the input shaft 2 via the piston plate 8.

The output gear hub 58 can include fasteners, such as extruded rivets 60, in one example, which can be used to secure the output gear hub 58 to a support plate 37 or other adjoining component. The extruded rivets 60 be integrally formed with the output gear hub 58 such that additional fastening components, which require separate assembly, are not required. The support plate 37 can be arranged radially around at least a portion of the input assembly, such as a flange of the input gear 1, the input shaft 2, and the piston plate 8. As used herein, the term input assembly can refer to any one or more of the input gear 1, the input shaft 2, the piston plate 8, as well as any of the housings surrounding these components, the cage 4, the balls 5, etc. The input assembly can also include an input housing 43, at least one tapered roller bearing 44a, 44b, an input cover 68, and an input seal plate 51. These components are described in more detail herein.

As shown in FIG. 6B, an internal surface or inner radial surface of the output gear ring 59 can include splines 61. These splines 61 can be configured as cutting teeth, splines, or projections that are generally configured to cut into any adjacent facing surface. For example, the splines 61 can be configured to engage with an outer radial surface 58a of the output gear hub 58 such that the output gear ring 59 is fastened to the output gear hub 58 while the outer gearing ring 59 is press-fit over an outer diameter of the output gear hub 58. The outer radial surface 58a of the output gear hub 58 can include a smooth outer surface prior to assembly, as shown in FIG. 6B, and the outer radial surface 58a can be permanently deformed via the splines 61. Once the splines 61 are engaged with the outer radial surface 58a of the output gear hub 58, a staking feature 62 (as shown in FIG. 6C) can be implemented to axially retain the output gear hub 58 with the output gear ring 59. In one configuration, the staking feature 62 can be formed on the output gear hub 58. One of ordinary skill in the art would understand that the staking feature 62 could alternatively be provided on the output gear ring 59. Once assembled, at least one outer ramp 63 can be machined on the output gear hub 58 such that the position of the outer ramp 63 can be aligned with respect to the gear teeth on the outer diameter of the output gear ring 59.

When torque is transmitted from the piston plate 8 to the balls 10, and then to the output gear ring 59, an axial force component is generated which drives the input shaft 2 and the piston plate 8 axially against at least one spring, such as spring set 14, through a thrust bearing 15 and a seal plate 17. The thrust bearing 15 can be configured to isolate the seal plate 17 and the spring set 14 from the rotation of the components connected to the engine.

A ramp ring 12 is provided that is configured to have its thrust loading reacted directly into a support plate 37. The ramp ring 12 is configured to have direct contact against the support plate 37, at least in an axial direction. The ramp ring 12 can be arranged radially inward from a portion of the output gear hub 58 and radially outward from a portion of the piston plate 8. During assembly and riveting, the support plate 37 is configured to apply a predetermined preload through the ramp ring 12, the balls 10, and the output gear hub 58 to keep the balls 10 securely tracking in their respective raceways 9a, 9b.

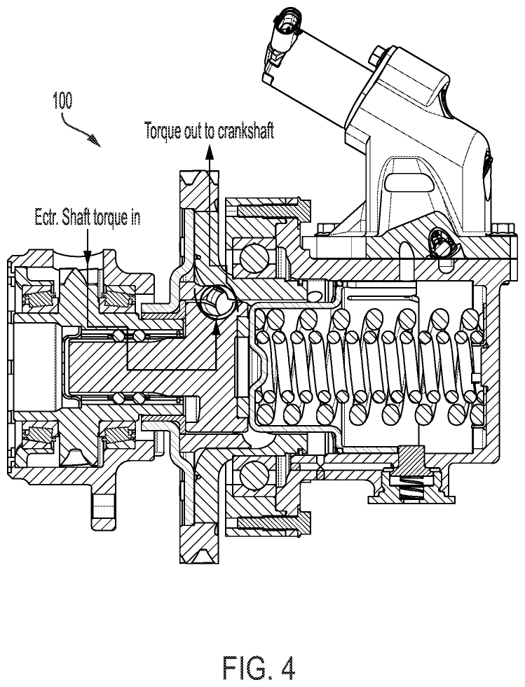

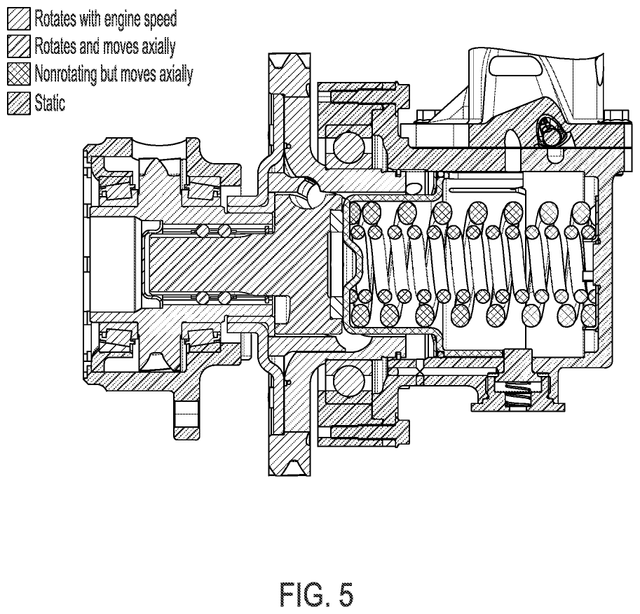

For a further illustration of the torque transmission via the phase adjuster 100, FIG. 4 shows an exemplary flow path for torque being input through the input assembly and output to the output assembly. FIG. 5 also provides a more detailed view of the various motion states of the components during an exemplary state.

Bearings can be implemented at various positions and interfaces throughout the phase adjuster 100. For example, a bearing 18 can be secured to the output gear hub 58 via a staking feature 70, as shown in FIG. 1. The bearing 18 can be arranged on a radially outer surface of the output gear hub 58. The bearing 18 can be a four-point contact bearing or multi-point contact bearing. More specifically, the output gear hub 58 can be staked to secure the bearing 18 in an axial direction between a radially outer surface of the output gear hub 58 and a radially inner surface of an output housing 21. The bearing 18 can be supported on the output housing 21, which can be connected via at least one fastener 22 to the hydraulic housing 23. The hydraulic housing 23 can be configured to provide at least one attachment point for an oil control valve (OCV) manifold 24 with at least one fastener 25 on top of a gasket 26. One of ordinary skill in the art would understand that various attachment or connection interfaces can be provided between the hydraulic housing 23 and the OCT manifold 24.

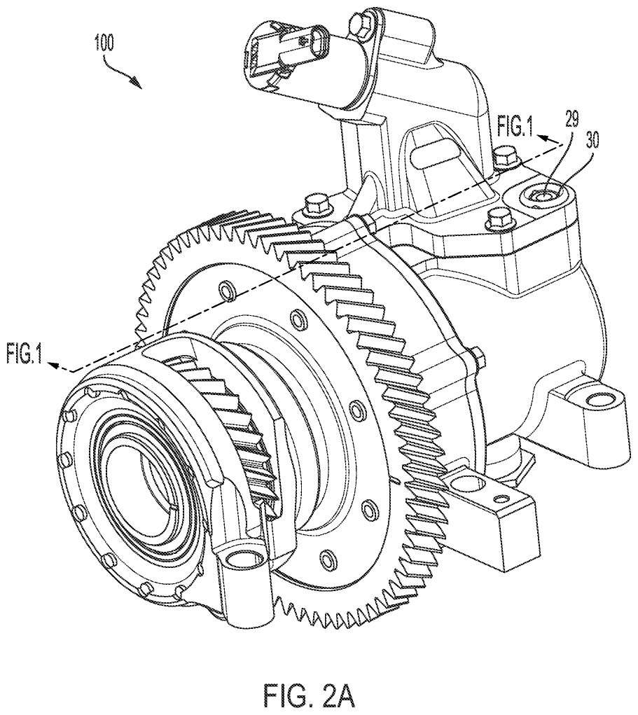

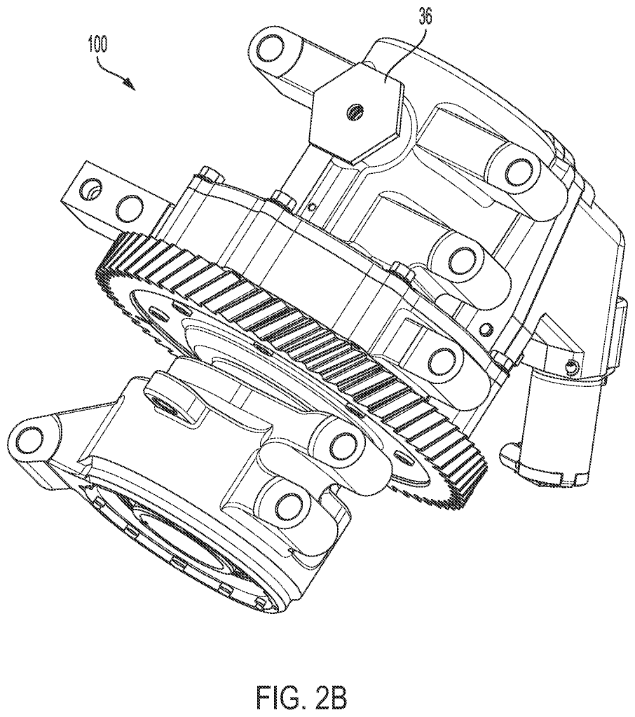

In one configuration, the remote OCV 27 can be mounted to the OCV manifold 24 with at least one fastener 28. As shown in FIG. 2A, the OCV manifold 24 generally can provide a hydraulic channel 29 for inlet engine oil pressure to enter the system via an inlet seal 30. The oil can enter the remote OCV 27 at its P-port 31 and from there can be directed to either an A-port 32 or a B-port 33. The A-port 32 can be connected to the left-hand side (with respect to FIG. 1) of the seal plate 17 and the input shaft 2, and if pressurized can provide a biasing force to assist moving the components axially to the right-hand side (with respect to FIG. 1, which can correspond to an advance direction). In a similar manner, the B-port 33 can be connected to the right-hand side of the seal plate 17 and provides the same force to the left-hand side (which can correspond to the retard direction).

The system can be locked in the high compression ratio (CR) position by default via a locking pin 34. The locking pin 34 can generally be configured to engage with the seal plate 17. The locking pin 34 can be biased by a spring 35 against a vented plug 36. While in the high CR position, the piston plate 8 is bottomed out from spring preload against a bushing 46 of the support plate 37, which is riveted to the output gear hub 58 via extruded rivets 60.

The locking pin 34, the spring 35, and the plug 36 can be housed within a collar 66 of the hydraulic housing 23. The collar 66 can be formed as a protrusion extending in a radial direction, in one example. The locking pin 34 can be configured to prevent the seal plate 17 from moving axially, thus keeping the piston plate 8 and the input shaft 2 fixed in the default high CR position. The locking pin 34 can be selectively actuated to engage the seal plate 17. To disengage the locking pin 34, pressure from the A-chamber is routed through at least one hole 67 formed within the hydraulic housing 23 to push the locking pin 34 outwards until it disengages from the seal plate 17. The at least one hole 67 can include a plurality of passages that can be formed via drilling. Based on this configuration, the hydraulic housing 23 is configured to directly house or retain the locking pin 34, the spring 35, and the plug 36, thereby reducing the need for any additional housing components for the locking assembly.

Based on the configuration disclosed herein, oil can be selectively provided to pressurize a specific chamber defined on either axial side of the seal plate 17. For example, if a change in CR from high to low (i.e. advance direction) is required, then the remote OCV 27 can pressurize the A-chamber while allowing flow out of the B-chamber. The torque force from the input gear 1 is then configured to push the input shaft 2 and the piston plate 8 in the advance direction against the spring set 14. As the components travel axially, the piston plate 8, the input shaft 2, and the input gear 1 are forced to phase about a rotational axis (X) due to the spiral shape of the raceways. In one configuration, this can phase an eccentric shaft with respect to the crankshaft and thus causes the change to a lower CR. Likewise, if a change from low to high (i.e. retard direction) is required, the A and B port pressure bias is reversed, and the spring set 14 is configured to force the components to travel axially back to the high CR position. If a position needs to be held, then the remote OCV 27 can hold a neutral position where flow is prevented in and out of the A and B chambers, thus hydraulically locking the system in a fixed position.

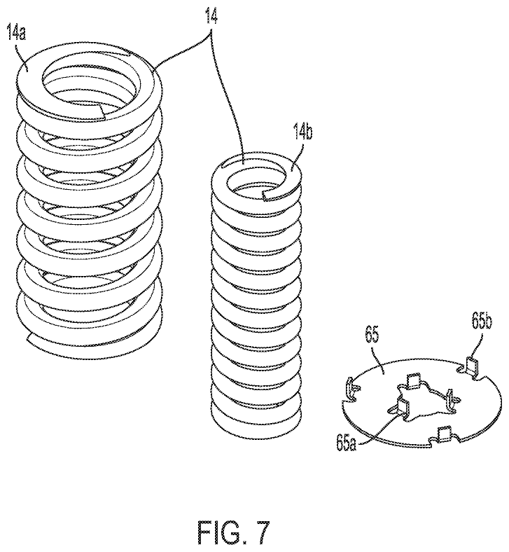

As shown in FIG. 7, the spring set 14 can include at least two springs 14a, 14b and can utilize a spring retainer plate 65, which simplifies assembly and ensures proper position of the springs 14a, 14b without needing complex retention or housing features. Although the term spring set 14 is used herein, one of ordinary skill in the art would understand that the spring set 14a could include a single spring or more than two springs. The spring retainer plate 65 can be formed as a stamped component. As shown in FIG. 7, the spring set 14 can include a first spring 14a and a second spring 14b. Both the first and second springs 14a, 14b can have an ovate cross-sectional profile. The first spring 14a can have a larger gauge than the second spring 14b in one example. The spring retainer plate 65 can include at least one inner retainer 65a on a radially inner edge, and at least one outer retainer 65b on a radially outer edge. Each of these retainers 65a, 65b can be configured to prevent any radial misalignment or movement of the spring set 14. In one example, each of the retainers 65a, 65b can include at least three retainers. The retainers 65a, 65b can be circumferentially offset from each other, in one example.

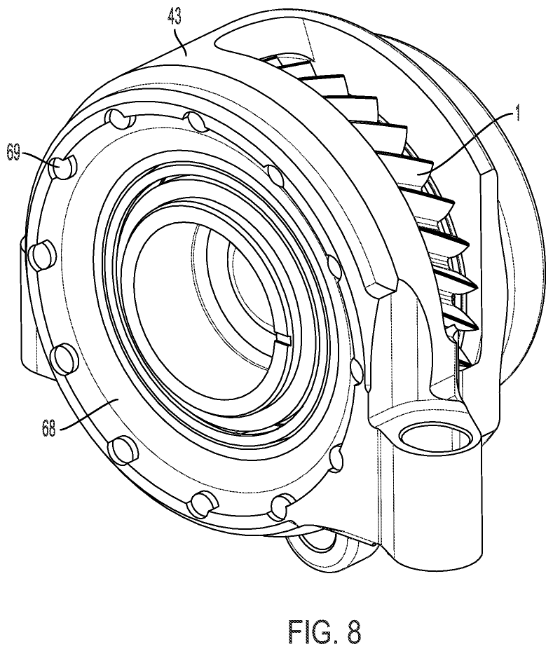

In one example, the input gear 1 can be supported to an input housing 43 through at least one bearing. The input housing 43 can be configured to house the input gear 1 and at least a portion of the input shaft 2. For example, a first and second tapered roller bearing 44a, 44b can be provided on either axial side of the input gear 1. The first and second tapered roller bearings 44a, 44b can support at least a portion of the input gear 1. The first and second tapered roller bearings 44a, 44b can be preloaded to the input housing 43 through an input cover 68. In one example, the input cover 68 can be formed as a stamped component. The input cover 68 can be pressed to apply a specific preload on at least one of the first or second tapered roller bearings 44a, 44b, and then can be axially secured via a staking feature 69 (as shown in FIG. 8), which can be applied via the input housing 43. In addition, the bushing 46 can be configured to support and center the input gear 1 to the support plate 37, while allowing the phasing relative motion to occur between those parts. The input housing 43, the output housing 21, and the hydraulic housing 23 can then be secured to the engine with fasteners and can be positioned on the engine via locating pins.

The system can include a plurality of seals at various interfaces. For example, an o-ring 48 can be provided to define a sealing interface between an outer surface of the seal plate 17 and an inner surface of the hydraulic housing 23. The o-ring 48 can be mounted on the seal plate 17 and can be configured to seal the A-chamber from the B-chamber and slide on the bore of the hydraulic housing 23 while phasing motion is occurring. The A-chamber and B-chamber are illustrated as (A) and (B) respectively in FIG. 1.

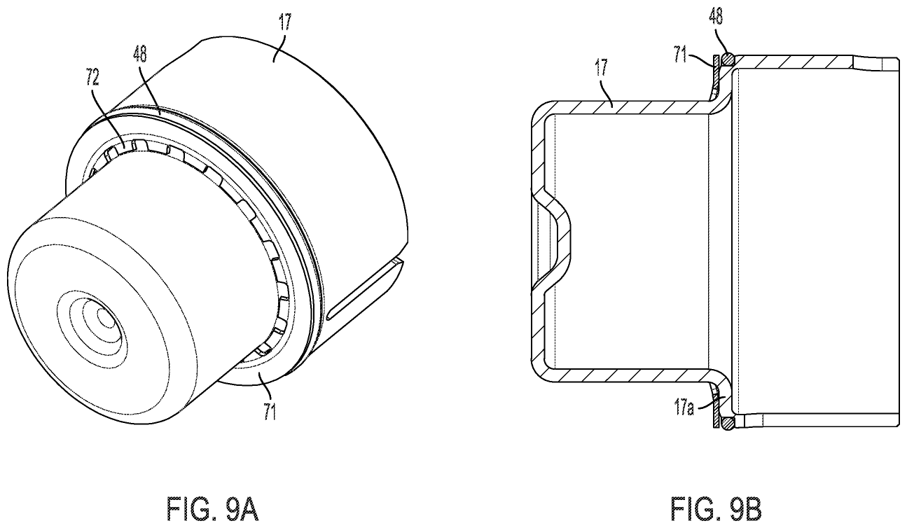

As shown in more detail in FIGS. 9A and 9B, a seal retainer plate 71 can be configured to retain the o-ring 48 on the seal plate 17. The seal retainer plate 71 can be configured to engage at least a portion of the seal plate 17. The seal retainer plate 71 can be formed as a stamped component, in one example. The seal retainer plate 71 can be press fit onto the seal plate 17. One of ordinary skill in the art would understand that other retention configurations are possible between the seal retainer plate 71 and the seal plate 17. The seal retainer plate 71 can include a plurality of fingers 72 that can engage with an outer surface of the seal plate 17 to secure the seal retainer plate 71. The seal plate 17 can include a shoulder 17a defined at a transition region between two axially extending portions having differing outer diameters. The shoulder 17a can define an abutment surface for engagement with the seal retainer plate 71. Additionally, the O-ring 48 can be retained radially outward from the shoulder 17a.

Among other seals or sealing interfaces, a dynamic seal 49 can be configured to seal the A-chamber from atmosphere between the output gear hub 58 and the hydraulic housing 23. A static o-ring 50 can be configured to seal the A-chamber from atmosphere between the output gear hub 58 and the support plate 37.

An input seal plate 51 can be press-fit inside a bore of the input gear 1 and can be configured to seal the A-chamber pressure from atmosphere. The input seal plate 51 can be formed as stamped sheet metal, and can be arranged in a radial plane that overlaps with the teething of the input gear 1. This placement of the input seal plate 51 helps reduce an overall axial footprint of the system. The input seal plate 51 can have a profile that is dimensioned to receive at least a portion of an axial end of the input shaft 2, as shown in FIG. 1.

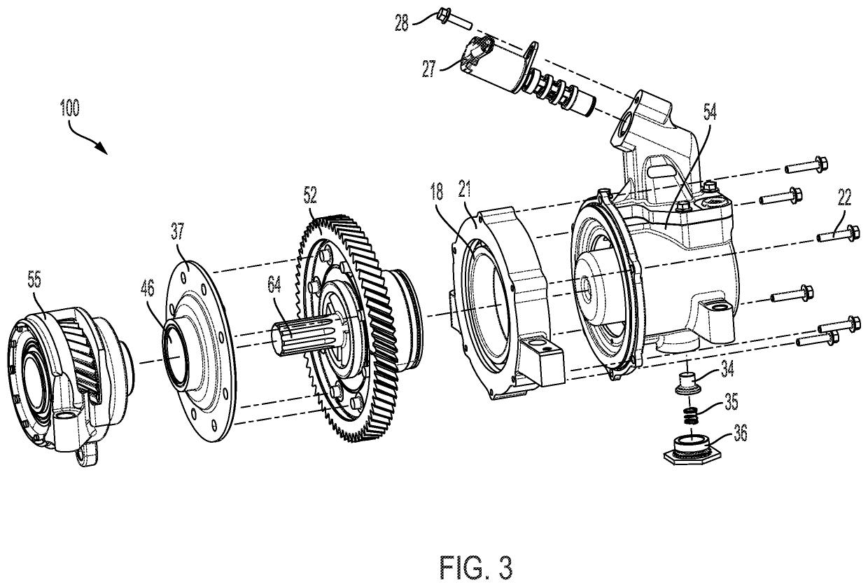

As shown in FIG. 3, the hydraulic housing assembly 54 can be constructed by assembling the gasket 26, the OCV manifold 24, the remote OCV 27, and the inlet seal 30 together with fasteners. The ball ramp actuator assembly 52, along with seal plate 17 and output housing 21, can be arranged over the thrust bearing 15, and the spring set 14 into the hydraulic housing assembly 54 and secured with fasteners. An input gear housing assembly 55 can be constructed by pressing the tapered roller bearings 44a, 44b onto the input gear 1, inserting the input gear housing assembly 55 into the input housing 43, then assembling the cage 4 and balls 5 before retaining this sub-assembly with a snap ring 56.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### LOG OF REFERENCE NUMERALS

Input gear 1
Input shaft 2
Ball spline 3
Cage 4
Balls 5
Raceways 6a, 6b
Piston plate 8
Raceways 9a, 9b
Balls 10
Ramp ring 12
Output gear 13
Spring set 14
First spring 14a
Second spring 14b
Thrust bearing 15
Seal plate 17
Shoulder 17a
Bearing 18
Output housing 21
Fastener 22
Hydraulic housing 23
OCV manifold 24
Fastener 25
Gasket 26
Remote OCV 27
Fastener 28
Hydraulic channel 29
Inlet seal 30
P-port 31
A-port 32
B-port 33
Locking pin 34
Spring 35
Vented plug 36
Support plate 37
Input housing 43
First and second tapered roller bearing 44a, 44b
Bushing 46
O-ring 48
Dynamic seal 49
Static o-ring 50
Input seal plate 51
Ball ramp actuator assembly 52
Hydraulic housing assembly 54
Input gear housing assembly 55
Snap ring 56
Output gear hub 58
Output gear ring 59
Rivets 60
Splines 61
Staking feature 62
Outer ramp 63
Body 64
Spring retainer plate 65
Retainers 65a, 65b
Collar 66
Hole 67
Input cover 68
Staking feature 69
Staking feature 70
Seal retainer plate 71
Fingers 72
Phase adjuster 100

What is claimed is:

1. A phase adjuster comprising:
an input gear and an input shaft connected to the input gear such that the input shaft is rotationally connected to the input gear and configured to be axially displaced, and a piston plate integrally formed with the input shaft; and
an output gear hub operatively connected to the input shaft via the piston plate, and an output gear ring connected to the output gear hub.

2. The phase adjuster according to claim 1, wherein the output gear hub is formed via stamping.

3. The phase adjuster according to claim 1, further comprising a support plate arranged radially around at least a portion of the input shaft, wherein the support plate is connected to the output gear hub via at least one extruded rivet formed on the output gear hub.

4. The phase adjuster according to claim 1, further comprising a seal plate and an oil control assembly configured to selectively provide pressure to a predetermined chamber on either axial side of the seal plate.

5. The phase adjuster according to claim 4, further comprising a spring assembly configured to engage the seal plate, wherein the spring assembly includes at least one first spring and at least one second spring, and a spring retainer plate including at least one inner retainer on a radially inner edge thereof and configured to support an end of the at least one second spring, and at least one outer retainer on a radially outer edge thereof and configured to support an end of the at least one first spring.

6. The phase adjuster according to claim 5, wherein the spring retainer plate is formed via stamping.

7. The phase adjuster according to claim 5, wherein the at least one first spring and the at least one second spring are wire springs with an ovate profile.

8. The phase adjuster according to claim 5, further comprising a hydraulic housing configured to support a locking pin that selectively engages the seal plate, wherein the hydraulic housing includes an integrally formed collar for supporting the locking pin.

9. The phase adjuster according to claim 4, further comprising:
a seal retainer plate configured to engage at least a portion of the seal plate;
a hydraulic housing; and
an o-ring configured to provide a seal interface between an outer surface of the seal plate and an inner surface of the hydraulic housing.

10. The phase adjuster according to claim 9, wherein the seal retainer plate is configured to be press fit onto the seal plate, and the seal retainer plate includes a plurality of fingers configured to engage the seal plate to retain the seal retainer plate on the seal plate.

11. The phase adjuster according to claim 1, further comprising:
an input housing configured to house the input gear and at least a portion of the input shaft;
at least one tapered roller bearing supporting at least a portion of the input gear; and
an input cover configured to engage directly against the at least one tapered roller bearing, wherein the input cover is configured to be axially retained via a staking feature formed on the input housing.

12. The phase adjuster according to claim 1, further comprising a bearing arranged on a radially outer surface of the output gear hub, wherein the output gear hub includes a staking feature for axially retaining the bearing.

13. The phase adjuster according to claim 1, further comprising an input seal plate configured to be press fit onto an interior surface of the input gear.

14. A phase adjuster comprising:
an input shaft configured to be rotationally connected to an input gear, and a piston plate integrally formed with the input shaft; and
an output gear hub operatively connected to the input shaft via the piston plate, and an output gear ring connected to the output gear hub via splines formed on the output gear ring engaging with the output gear hub.

15. The phase adjuster according to claim 14, further comprising a support plate arranged radially around at least a portion of the input shaft,
wherein the output gear hub is a stamped component, and the support plate is connected to the output gear hub via at least one extruded rivet formed on the output gear hub.

16. The phase adjuster according to claim 14, further comprising:
a seal plate and an oil control assembly configured to selectively provide pressure to a predetermined chamber on either axial side of the seal plate,
a spring assembly configured to engage the seal plate, wherein the spring assembly includes at least one first spring and at least one second spring, and a spring retainer plate including at least one inner retainer on a radially inner edge thereof and configured to support an end of the at least one second spring, and at least one outer retainer on a radially outer edge thereof and configured to support an end of the at least one first spring.

17. The phase adjuster according to claim 16, further comprising a hydraulic housing configured to support a locking pin that selectively engages the seal plate, wherein the hydraulic housing includes an integrally formed collar for supporting the locking pin.

18. The phase adjuster according to claim 16, further comprising:
a seal retainer plate configured to engage at least a portion of the seal plate;
a hydraulic housing; and
an o-ring configured to provide a seal interface between an outer surface of the seal plate and an inner surface of the hydraulic housing.

19. The phase adjuster according to claim 18, wherein the seal retainer plate is configured to be press fit onto the seal plate, and the seal retainer plate includes a plurality of fingers configured to engage the seal plate to retain the seal retainer plate on the seal plate.

20. The phase adjuster according to claim 14, further comprising:
an input housing configured to house the input gear and at least a portion of the input shaft;
at least one tapered roller bearing supporting at least a portion of the input gear; and
an input cover configured to engage directly against the at least one tapered roller bearing, wherein the input cover is configured to be axially retained via a staking feature formed on the input housing.
